(19) United States
(12) Patent Application Publication
(10) Pub. No.: US 2009/0090884 A1
(43) Pub. Date: Apr. 9, 2009

(54) WATER TAP OR FAUCET

(75) Inventor: Michael Wellesley Grahame Jarvis, Glasgow (GB)

Correspondence Address: PEPPER HAMILTON LLP, ONE MELLON CENTER, 50TH FLOOR, 500 GRANT STREET, PITTSBURGH, PA, 15219, US

(73) Assignee: HORNE ENGINEERING LIMITED, Renfrewshire (GB)

(21) Appl. No.: 12/158,005

(22) PCT Filed: Dec. 22, 2006
(86) PCT No.: PCT/GB2006/004921

§ 371 Date: Oct. 17, 2008

(30) Foreign Application Priority Data
Dec. 23, 2005 (GB) 0526333.0

(51) Int. Cl. F16K 31/60

(52) U.S. Cl. 251/231

(57) ABSTRACT

A lever action tap or faucet has a rotary control for manually regulating the flow of water through the tap to a spout, and is adapted for hospital environments, including pre-surgical scrubbing up. The control comprises a long lever arm and a short lever arm, either lever arm being operable to operate the control, the lever arms being mounted with a predetermined angular separation about the axis. The angle of rotation between the open and closed states is substantially equal to 90°. The arrangement is such that the long lever is arranged to rotate upwards and away from the user in moving from the open state to the closed state. The short lever arm is arranged to rotate downwards and away from the user, in moving from the closed state to the open state.

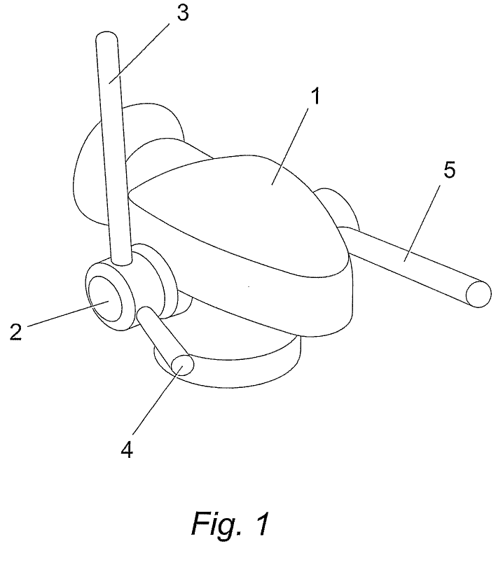

### CROSS-REFERENCE TO RELATED APPLICATIONS

This application claims the priority to the benefit of Great Britain Patent Application No. 0526333.0, filed Dec. 23, 2005. This application was also filed as International Patent Application PCT/GB2006/004921 with an International Filing Date on Dec. 22, 2006, with subsequent publication as International Publication Number WO 2007/072058 on Jun. 28, 2007. The disclosures of each of the aforementioned patent documents are incorporated herein by reference in its entirety.

### BACKGROUND

The invention relates to taps, also referred to herein as faucets, for the delivery of water to a user at a sink or basin. The invention is of particular application in settings where hygiene is a priority, as for example in hospitals, but is not limited to any particular setting.

In a hospital, when surgical staff scrub up before an operation they are required to wash or scrub their hands and forearms prior to starting the operation and handling the patient. It has been customary for them to use a lever action tap which can be turned on and turned off by using an elbow or forearm. The problem with this arrangement is that they touch the lever at the same place when turning the tap on, prior to scrubbing up, and off again after scrubbing up. Turning the tap on and off requires some dexterity with an elbow and is not easy. Aside from the high level of cleanliness expected around the operating theatre, it is increasingly realised that cleanliness is important for infection control throughout hospitals and other institutions, because of the spread of MRSA and other antibiotic-resistant bugs.

### SUMMARY

The present invention has as its object to provide taps permitting an improved combination of ergonomics and infection control.

The invention in a first aspect provides a lever action tap comprising a body on which is mounted at least one rotary control for manually regulating the flow of water through the tap to a spout, the control having open and closed states separated by rotation less than 180° about a rotation axis, the control comprising a long lever arm and at least one short lever arm, either lever arm being operable to operate the control, the lever arms being mounted with a predetermined angular separation about the axis.

With this dual-lever arrangement the hand, which is easier than the elbow, can be used to open the tap by moving a short lever, and since this is done prior to scrubbing the surface of this lever may be contaminated by the hand. After scrubbing the tap can be turned off by moving the long lever by elbow and since this lever has not been touched prior to scrubbing it is free from contamination and, therefore, cannot contaminate the elbow of the user.

The angle of rotation between the open and closed states is preferably on the order of 90°, but could be in the range 50-100°. Quarter-turn mechanisms (90°) are well-developed, and common in the art. Other configurations having 100° and 120° are also known, however.

The arrangement of the lever arms and orientation of the rotation axis in relation to the intended mounting orientation of the tap may be such that, when the tap is mounted for use, the long lever arm will be approximately vertical in the closed state of the control, and projecting generally towards the user in the open state.

The rotation axis of the control may be substantially horizontal, and transverse to the typical stance of the user. These are not strict requirements, of course. The orientation of the rotation axis may in practice be set (out of ergonomic and manufacturing considerations) within a range of angles up to 15° or even 30° above and below, forward and rearward of truly horizontal and transverse to the user's line of approach.

The long lever arm may be arranged to rotate upwards and away from the user in moving from the open state to the closed state.

The long lever arm may be arranged to rotate slightly beyond vertical and away from the user, for example to an angle of 5 to 15° or 30° beyond vertical, before completing said rotation to the closed state.

The arrangement of the lever arms and mounting means of the tap may be such that the short lever arm projects generally toward the user in the closed state, moving to a more vertical orientation in the open state.

The short lever arm may be arranged to rotate downwards and away from the user, in moving from the closed state to the open state.

The short lever may be arranged to lie at an angle slightly below horizontal in the closed state, for example in the range 5 to 15° or 30° below horizontal.

The angular separation between the lever arms may be in the range 80° to 160°, preferably 90° to 150°, and more preferably between 100° and 140°.

The long lever arm may extend 12 cm or more from the rotation axis. 15 cm is typical for elbow operation, but the long lever in the present tap may extend more than 16 cm if desired. The short lever arm may extend less than 110 cm from the rotation axis of the control. The long lever arm may extend to more than twice the length of the short lever arm, measured from their common rotation axis.

One or both lever arms may be provided with an ergonomically shaped extremity for comfortable operation.

The invention in a second aspect provides a lever action tap comprising a body on which is mounted at least one rotary control for manually regulating the how of water through the tap to a spout, the control having open and closed states separated by rotation less than 180° about a rotation axis, the control comprising first and second lever arms, either lever arm being operable to operate the control, the lever arms being mounted with a predetermined angular separation about the axis, wherein the rotation axis is oriented transversely with respect to the typical stance of a user so that said lever arms rotate towards and away from the user in moving the control be teen said open and closed states.

The first lever arm may be arranged to rotate upwards and away from the user in moving from the open state to the closed state.

The second lever arm may be arranged to rotate downwards and away from the user, in moving from the closed state to the open state.

The various optional and preferred features of the first aspect of the invention can be applied equally in implementation of the second aspect. For example, the first lever arm may be significantly longer than the second lever arm.

In either aspect, the invention includes embodiments wherein the tap is a mixer tap having inlets for cold and hot water supplies and having a second control of the same form as the first-mentioned control. Said first and second controls may be arranged at opposite sides of the tap body, either side of the spout portion. The rotation axes of the two controls may be aligned with one another, or may have an angular deviation between them.

The mixer tap body may incorporate a thermostatic element for controlling mixing of water from hot and cold water supplies, to provide a safe hot output temperature, the first control regulating flow of the safe temperature hot water and the second control regulating flow of unmixed cold water to the spout portion.

Safe hot supplies are commonly required in hospitals and other care institutions, because of the risk of scalding by water at temperatures much above 40° C.

### BRIEF DESCRIPTION OF THE DRAWINGS

Embodiments of the invention will now be described, by way of example only, by reference to the accompanying drawing, in which the sole FIGURE is a perspective view of a tap or faucet embodying the present invention.

### DETAILED DESCRIPTION OF THE EMBODIMENTS

In the FIGURE, tap body 1 is mountable to a wall or similar support so as to present a spout portion toward the user (referred to as the front of the body). Pipe connections for hot and cold water enter in this example through the wall-mounting portion at the rear. The body has a manually operable control on either side. A first control, typically the one on the user's left hand side, is provided for obtaining hot water and a second control is provided for obtaining cold water.

Each control comprises a hub 2, with long and short lever anus 3 and 4 respectively projecting from the hub for purpose of operating the tap by rotating the hub about a transverse axis (that is, an axis running left-right from the point of view of the user). The short lever arm 4 is intended for use in opening the tap, and projects generally forward (presenting itself toward the user) when the tap is closed. The arm 4 rotates downwards to open the tap. The long lever arm 3 projects from hub 2 at a different angle, and is intended for closing the tap. With the tap ‘off’, the long lever 3 is substantially vertical, but rotates forward to present itself to the user when the tap is opened. The long lever 5 of the right hand control is shown in the forward or open position allowing easy access for closing the tap with hand, for example the back of the hand, or the elbow or forearm. In the vertical (closed) position, the long arm 3 is preferably at an angle slightly beyond vertical, away from the user. This avoids the weight and moment of the long lever tending to open the control unintentionally.

Opening the tap before a hand-washing operation, the hand will be dirty or contaminated and it is the intent of this invention that the cross-contaminating dirt will be confined to the short lever. The lever is long so that closing can be done with the forearm or elbow, thus further reducing the risk of re-contamination of the now-clean hand or forearm. The angle between the long and short lever arms on each hub is fixed to an amount optimal for ergonomic operation in the intended application. In the example shown the angle is approximately 120°. It will normally be in the range 80-160°, preferably greater than 90°.

Additional advantages of the specific arrangement shown include (i) the fact that the “contaminated” lever arm ties below the “clean” lever arm, and hence contaminants cannot run off from the one to the other and (ii) the forearm does not need to be inverted as with conventional long lever taps, reducing the tendency for water to run from the hand along the forearm.

In the embodiment shown, the controls both rotate about axes which are aligned with one another, horizontal and in a vertical plane normal to the line of approach of the user. The lever arms are orthogonal to the axes. However, the rotation axes of the two controls do not need to be strictly horizontal, nor exactly aligned with one another, nor in a common transverse vertical plane. The lever arms need not project strictly orthogonal to the axis of rotation. Rather the orientation of the axes and the angles of the lever arms. Although the lever arms as shown are simple rod-like projections, the arms may be shaped toward the ends to make operation more comfortable or sure. A broad, blade-like portion would be one option.

In a particular embodiment, the body houses a thermostatic mixing module, so that the ‘hot’ water control in fact delivers mixed hot water at a safe temperature. Further detail of these internal functions can be seen in our co-pending application GB 0526331.4 having the same priority date as the present application. The present invention is equally applicable to single-control devices. In these and other respects the invention is not to be taken as limited to the embodiments shown or described, and is rather defined by the appended claims.

What is claimed is:

1. A lever action tap device comprising:
a body on which is mounted at least one rotary control for manually regulating a flow of water through the tap to a spout, the at least one rotary control having open and closed states separated by rotation less than 180° about a rotation axis, the at least one rotary control comprising a long lever arm and at least one short lever arm having a fixed angular separation, either lever arm being operable to operate the at least one same rotary control.

2. The device of claim 1 wherein an angle of rotation between the open and closed states is about 50° to about 100°.

3. The device of claim 2 wherein an angle of rotation between the open and closed states is about 90°.

4. The device of claim 1 wherein the long lever arms and orientation of the rotation axis in relation to an intended mounting orientation of the tap is such that, when the tap is mounted for use, the long lever arm will be vertical in the closed state of the at least one rotary control, and projecting towards a user in the open state.

5. The device of claim 1 wherein the rotation axis of the control is horizontal, and transverse to a stance of a user.

6. The device of claim 1 wherein the long lever arm is arranged to rotate upwards and away from a user in moving from the open state to the closed state.

7. The device of claim 6 wherein the long lever arm is arranged to rotate beyond vertical and away from a user, before completing the rotation to the closed state.

8. The device of claim 1 wherein the at least one short lever arms and mounting means of the tap is such that the at least one short lever arm projects toward a user in the closed state, moving to a vertical orientation in the open state.

9. The device of claim 8 wherein the at least one short lever arm is arranged to rotate downwards and away from a user, in moving from the closed state to the open state.

10. The device of claim 8 wherein the at least one short lever arm is arranged to lie at an angle below horizontal in the closed state.

11. The device of claim 1 wherein an angular separation between the long lever arms and the at least one shorter lever arm is about 80° to about 160°.

12. The device of claim 11 wherein an angular separation between the long lever arms and the at least one shorter lever arm is about 100° to about 140°.

13. The device of claim 1 wherein the long lever arm extends at least 12 cm from the rotation axis.

14. The device of claim 1 wherein the at least one short lever arm extends less than 10 cm from the rotation axis of the at least one rotary control.

15. The device of claim 1 wherein the short lever arm extends less than 10 cm from the rotation axis of the at least one rotary control.

16. The device of claim 1 wherein the long lever arm extends to more than twice a length of the at least one short lever arm, measured from their common rotation axis.

17. A lever action tap device comprising:
a body on which is mounted at least one rotary control for manually regulating a flow of water through a tap to a spout, the at least one rotary control having open and closed states separated by rotation less than 180° about a rotation axis,
the at least one rotary control comprising first and second lever arms having a fixed angular separation, the first or the second lever arms being operable to operate the at least one rotary control, wherein the rotation axis is oriented horizontal and transversely with respect to a stance of a user so that so the first and second lever arms rotate towards and away from the user in moving the at least one rotary control between the open and closed states.

18. The device of claim 17 wherein the first lever arm is arranged to rotate upwards and away from the user in moving from the open state to the closed state.

19. The device of claim 17 wherein the second lever arm is rotates downwards and away from the user, in moving from the closed state to the open state.

20. The device of claim 14 wherein the tap is a mixer tap having inlets for cold and hot water supplies and having a second control.

21. The device of claim 20 wherein the first and second controls are arranged at opposite sides of the tap body, either side of the spout.

22. The device of claim 20 wherein the rotation axes of the first controls is aligned with the second control.

23. The device of claim 20 wherein the mixer tap body incorporates a thermostatic element for controlling mixing of water from hot and cold water supplies, to provide a safe hot output temperature, the first control regulating flow of the safe temperature hot water and the second control regulating flow of unmixed cold water to the spout.
